(19) United States
(12) Patent Application Publication
(10) Pub. No.: US 2013/0254148 A1
(43) Pub. Date: Sep. 26, 2013

(54) METHOD OF MEASUREMENT USING FUSION OF INFORMATION

(71) Applicant: Gavin Powell, Newport (GB)

(72) Inventor: Gavin Powell, Newport (GB)

(73) Assignee: EADS UK LIMITED, LONDON (GB)

(21) Appl. No.: 13/876,959

(22) PCT Filed: Sep. 30, 2011
(86) PCT No.: PCT/GB2011/051867

§ 371 Date: May 15, 2013

(30) Foreign Application Priority Data
Oct. 1, 2010 (GB) 1016532.2

(51) Int. Cl. G06N 5/02

(52) U.S. Cl. CPC G06N 5/02
USPC 706/46

(57) ABSTRACT

It is often necessary to make the best possible measurement of an object given a set of approximate assessments of its true state. As states change over time, or more information is made available, the set of assessments of the relative likelihood of the various possibilities has to be revised. An example might be the identification of an observed object such as a person or an aircraft, or the generation of a weather forecast from several pieces of information distributed in time or place, or both. The invention relates to methods for making the best possible measurement of an object, described by a powerset T, given uncertain data in terms of the elements of the powerset m_{fused}, comprising the following steps: a) Set up the state of the measurement with any prior knowledge if available, or otherwise as ignorant, for the fused measurement, m_{fused}; b) Receive the new data; c) Put the new data into the powerset mₘₑₐₛᵤᵣₑₘₑₙₜ; d) Work out the precision of m_{fused} by evaluating the distribution of data across the m_{fused}; e) Disjunctively discount mₘₑₐₛᵤᵣₑₘₑₙₜ by an amount depending on the result of Step d to get m_{measurementd}; f) Conjunctively discount mₘₑₐₛᵤᵣₑₘₑₙₜ by an amount depending on the result of Step d to get m_{measurementc}; g) Disjunctively combine m_{fused} with m_{measurementd} to get m_{fusedd}; h) Conjunctively combine m_{fused} with m_{measurementc} to get m_{fusedc}; i) Combine m_{fusedd} and m_{fusedc} to get a new average value m_{fused}; and j) Return to (b), if there are more data; else end the process. Such a method balances the tendencies of known methods towards throwing away useful information available in measurements that disagree.

### CROSS-REFERENCE TO RELATED APPLICATIONS

This application is a national stage entry of International Application Serial No. PCT/GB2011/051867 filed Sep. 30, 2011 (International Publication No. WO 2012/04220 A1), the disclosure of which is incorporated herein by reference.

### TECHNICAL FIELD

The invention relates to a method of measurement involving fusing or combining information; that is, of pooling evidence about an object, such as an event or object under investigation, in order to update existing information and estimates about the identity or nature of the object when new information is received, for instance from sensors.

### OVERVIEW

It is a common task for an ‘agent’, such as a person or a computer program, to create a set of subjective quantified beliefs, or approximate assessments analogous to probabilities, of the true state of some object.

Generally, from lack of knowledge, this is an imprecise evaluation of the true state. As states change over time, or more information is made available to the agent, they may wish to update or alter their set of beliefs. An example might be the identification of an observed object such as a person or an aircraft, or the generation of a weather forecast from several pieces of information distributed in time or place, or both.

To take an example, in an identification procedure, sensing devices can classify an enemy target from a selection of ‘known’ objects. This may be from human intelligence, radar, LADAR etc. This object classification will occur iteratively over time, providing a new measurement, or classification, at regular time intervals. To obtain a more informed overall classification, all sensors' measurements need to be fused at each time interval, and recursively over time, as shown in Equation 1.

S_{1 . . . t}=S_{1 . . . t-1}+Sₜ Equation 1

where S is the fusion of previous sensor measurements and s is the sensor measurement at time t. From the fused data a better classification or assessment of the object can be made, from S_{i . . . t}. As will be explained, current set-based methods are inadequate, because of the fusion method used. The present invention aims to overcome these problems by providing a much more intelligent form of fusion method, designed specifically for iterative situations.

### BACKGROUND

If one is presented with more than one piece of information about a subject, from either the same measurement source over time or multiple sources, or even multiple sources over time, then it is normal to want to combine all of this information, to increase the accuracy, or confidence, of the measurement. This combination will enable a more informed decision to be made, using all available information, as opposed to just looking at a single piece of information. An example of such a task would be classifying an object where information is received continuously or intermittently over time, from a variety of sensors, and one wants to recursively combine, or fuse, this information, so as to obtain a continuously updated measurement.

Set-based methods have been in existence for some time, originating from work done by Dempster and Shafer who formulated the popular Dempster-Shafer Theory (DST). See A. P. Dempster, “A Generalisation of Bayesian Inference”, Journal of the Royal Statistical Society, Series B30, pp. 205-247, 1968, and G. Shafer, “A Mathematical Theory of Evidence”, Princeton University Press, Princeton, N.J. 1976. Its popularity lies in its relative simplicity, but there are many issues related to its use, and care must be taken.

Extensions of the DST theory exist that try to overcome some of its failings, primarily the Transferable Belief Model (TBM)—see P. Smets, R. Kennes, “The Transferable Belief Model”, Artificial Intelligence, V66, 1994, pp. 191-234; and Dezert Smarandache Theory (DSmT): Jean Dezert, “Combination of Paradoxical Sources of Information within the Neutrosophic Framework”, Proceedings of the First Int. Conf. on Neutrosophics, Univ. of New Mexico, Gallup Campus, Dec. 1-3, 2001. Patents exist in the area of using DST to perform classification (U.S. Pat. No. 6,944,566) and decision-making and using DSmT for fault diagnosis (U.S. Pat. No. 7,337,086). TBM has been used for fusing information to understand vehicle occupancy, as shown in US Pat. Pub. 2006/0030988 (Farmer).

There are three points that need to be taken into account when looking at these approaches. First is whether they fuse information iteratively. Secondly is whether they retain the value of the empty set. Thirdly is whether they adapt to the data as it changes through time. The empty set represents, as it were, the hypothesis that the object to be identified or classified is not within the known range of possibilities or hypotheses (“open-world”), where the range of known possibilities, or ‘elements’, represents the ‘world’; on the other hand, a system which forces an assignment to the known range is called “closed-world”. The 2ⁿ possible combinations of the elements are each known as a ‘hypothesis’, and collectively as the ‘powerset’—this is shown in FIG. 1, to be discussed in more detail below. Here, n is the number of elements in the world, or the number of possible singleton outcomes of the measurement or classification process.

In the real world, each successive measurement or input will be to a certain extent in conflict with existing data. On a strict interpretation, any such conflict must be interpreted as meaning that the object is not described by any of the known hypotheses. That is, the weighting of the empty set becomes larger. However, such a conclusion does not reflect the uncertainty in the input information. Some way has to be found of dealing with this tendency.

The DST method normalizes the empty set on each iteration and therefore throws away the information associated with it (i.e. the conflict between information sources or the confidence that the true state corresponds to something outside of the known world). It also has no concept of adapting to its environment. The TBM has no normalization and so keeps the empty-set information. This is a more suitable approach for many applications, but unfortunately becomes its downfall when used recursively with conventional combination rules, making it impossible to do any recursive fusion with the TBM.

Finally, DSmT adds more complexity to the simple and elegant DST. It goes some way to retaining the empty set value, allowing for recursive fusion to take place but not adapting to its environment. Research is still very active in this area and has applications toward data fusion for classification: B. Pannetier and J. Dezert, GMTI and IMINT Data Fusion for Multiple Target Tracking and Classification, Fusion 2009, Seattle, 6-9 Jul. 2009.

These approaches tend to be reliant upon the conflict coming from the sources of data. Situations can easily arise where there is no conflict between information sources, yet there is still uncertainty. It is desirable to capture this uncertainty and accordingly to improve the reliability of the result.

These issues are well known and have been accepted for some time within the community. The death of the founder of the TBM has stunted work in that area, and the limits of the DST were seen to have been reached some time ago.

The article “Towards a combination rule to deal with partial conflict and specificity in belief function theory” by A. Martin et al., 10th Conference of the International Society of Information Fusion, 2007, pages 313-320, presents a discussion of conjunctive and disjunctive combinations, redistribution and also weighting of expert responses. The article “Adaptive combination rule and proportional conflict redistribution rule for information fusion” by M. C. Florea, J. Dezert, P. Valin, F. Smarandache, Anne-Laure Jousselme, Presented at Cogis '06 Conference, Paris, March 2006; http://www.see.asso.fr/cogis2006/pages/programme.htm likewise uses both conjunctive and disjunctive combination. However, the process still takes place in a closed world, so is in particular unsuitable for recursive applications.

The present invention aims to make it possible to utilise the TBM (which is an improvement/extension of DST) and make it flexible and usable in more realistic iterative and recursive real-world scenarios, which it was previously unable to do.

### SUMMARY OF THE INVENTION

The invention is concerned with a method for measurement involving fusing multiple sets of data about an object, an interaction of objects or a change in an object after or through interaction with another object or other objects, and is defined in claim 1 as a method, and in claim 11 as an apparatus. The “object” could be a physical object or system as such, or an event relating to such an object or set of objects; for convenience and brevity the word “object” will be used.

Methods embodying the present invention, known as GRP1, have two distinct steps that allow for fusion of data from measurements to be performed recursively in order to make the best use of the available uncertain data. First, the steps in which the pieces of information are fused applies existing methods, in a particular manner, to allow for iterative fusion. Secondly, intelligent decisions are made as to how much influence the incoming information can have on the classification. These decisions are based on a novel adaptive-weighting method. Preferred embodiments of the invention are based on a combination of these steps.

For iterative fusion to be able to take place using set-based theory, dominance by the empty set needs to be avoided. This needs to be done in a manner that does not simply redistribute the empty set after each iteration. The value given to the empty set is a valuable measure that should not be thrown away, as in other techniques. To accomplish this, embodiments of the invention combine information in two different ways. An average (Equation 2) of the disjunctive (Equation 3) and conjunctive (Equation 4) combinations of the data provides the necessary balance between precision and vagueness to give a meaningful answer, and to avoid domination by the empty set. In a simple case the mean can be taken:

mₘₑₐₙ(A)=½m_{1⊕2}(A)+m₁ [symbol] ₂(A) Equation 2

where m(A) is the “mass” given to hypothesis A, taken from the following combination rules, and m₁ and m₂ are the two sets of information to be fused, where each possible hypothesis in Ω (the union of all elements of the powerset) has a mass assigned, and B and C are hypotheses within these worlds:

m_{1⊕2}(A)=Σ_{A=B∪C}m₁(B)m₂(C) Equation 3

(disjunctive) and

m₁ [symbol] ₂(A)=Σ_{A=B∩C}m₁(B)m₂(C) Equation 4

(conjunctive)

Thus, “disjunctive” means that an element is added to the sum if A is equivalent to both B and C, and “conjunctive” means that it is added if A is equal to the common elements of B and C.

Here a “world” contains the elements that are known about and understood, and can be reasoned with. Each of the 2ⁿ combinations of those elements in the world, including the empty set Ø, is called a hypothesis, and collectively these hypotheses are the powerset, Θ (See FIG. 1). An ‘agent’ attaches quantified subjective beliefs about the true state to each of these hypotheses, where a belief signifies how much weight is to be given to one of the elements in that hypothesis as representing the true state. The powerset with mass (beliefs) assigned is signified by m. There are various powersets within the process, but in an iterative process the main two are: firstly one m_{fused} that describes the beliefs of the fused measurements up to time t−1, and secondly one mₘₑₐₛᵤᵣₑₘₑₙₜ that describes the incoming information as a result of a further measurement at time t. It is with the combination of these two that this application is chiefly concerned.

Secondly, to enable the method to fuse information both iteratively and intelligently, a novel means of distributing the amount of weighting (discounting) can be applied to the information prior to its disjunctive and conjunctive combination. Regular discounting will move mass to the uncertain set Ω, which makes the system vaguer as there is less trust in the incoming information. This is fine for conjunctive combination, as it counteracts the natural move of belief to the empty set that occurs through the conjunctive combination rule. For the disjunctive combination one must ensure that the discounting adds vagueness by moving mass to the empty set, to counteract the natural move of belief to the uncertain set Ω, as occurs with the disjunctive rule of combination. If it is not discounted in this manner, then the iterative nature of the problem will make the method converge undesirably.

The weighting factor is a sign of the precision and certainty in the system, and determines how much it can be influenced by new information. If for instance the system is one for identifying aircraft and it has been instructed for the last 2000 readings that the object to be identified is an aircraft of type GR7, then there will be great precision and certainty in its classification. It will take many conflicting readings for the system then to change that classification. If the system is very unsure of the target type, then it will be easy to alter its classification. This acts as a memory to the system of the information that it has received over time.

### BRIEF DESCRIPTION OF THE DRAWINGS

For a better understanding of the invention, embodiments of it will now be described, by way of example, with reference to the accompanying drawings, in which:

FIG. 1 shows how the powerset is made up of a distribution of beliefs about certain possible descriptions of the (real) world, or the object of study; and

FIG. 2 shows an example of an application of the method to multiple-sensor layout, for identifying a moving vehicle.

### DETAILED DESCRIPTION

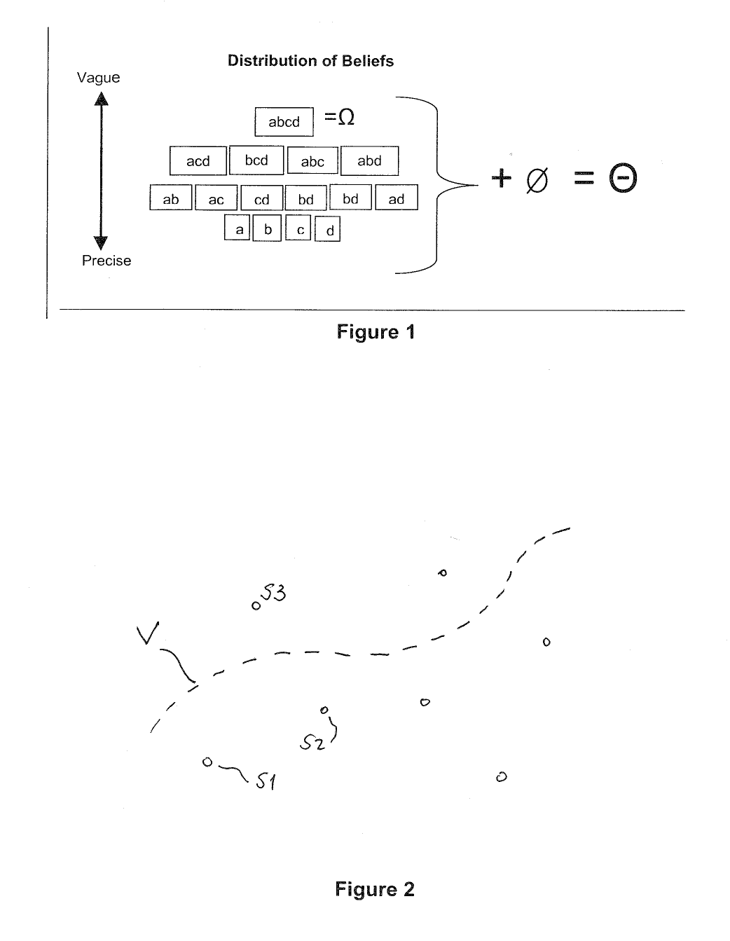

In a typical method using the invention, the powerset, denoted Θ, will have beliefs associated with its hypotheses regarding the true state of the object being measured, either from a sensor of some sort or simply human input, e.g. typed in at a keyboard or a computer, or by fusing it with another powerset. Evaluation of how that belief is distributed throughout the powerset, Θ, will show how vague, or precise, that powerset is. FIG. 1 shows various possible assignments of (usually mutually exclusive) beliefs a, b, c, d, which may be, say, four different types of aircraft. The box a represents a particular identification and will, following a measurement, have a mass associated with it. The box ab represents a belief that the object is a or b, but with no information as to the relative likelihood as between these two; similarly for the other boxes. The empty set, i.e. the possibility that the object is not one of the known possibilities, is shown as Ø.

If values are assigned to the singleton sets a, b, c, d, i.e. those which have only one element, then the world is precise and any decisions are well educated. If beliefs are given to the uncertain set, Ω, that is, the box abcd, then the world is vague and any decisions made from this are uneducated.

This notion of precision is quite important, and can be used to determine how the incoming information is fused. If the powerset is showing a high degree of precision then the identification is relatively certain and it should take a significant number of contradictory readings to alter the belief. Alternatively, if the existing assessment is completely vague about knowledge and beliefs, then the system will be more accepting of new information. This concept needs to be accounted for when information is being fused.

It is known to ‘discount’ incoming information—P. Smets, “Belief Functions: the disjunctive rule of combination and the generalised Bayesian theorem”, International Journal of Approximate Reasoning, 9, pp. 1-35, 1993. This discounting process will weight the incoming data and is a measure of how much it is to be trusted.

This known discounting of data is described by Equation 5:

m^{α}(A|x)=(1−α)·m(A) ∀A⊂Ω,A≠Ω

m^{α}(A|x)=[(1−α)·m(A)]α A=Ω Equation 5

Here, the notation m^{α}(A|x) means the mass assigned to hypothesis A given that it is already known that event x has occurred. This works perfectly well when one is dealing with the conjunctive combination rule (Equation 4), because the discounted masses are passed toward the empty set, Ø. For the disjunctive rule (Equation 3) the procedure will only force the belief to be vaguer and encourage convergence toward the uncertain set, Ω. When using the disjunctive combination rule, according to the invention, one must discount using Equation 6 below. This will allow the discounted mass to be passed to the empty set, which when fused with the “cautious” combination rule (i.e. Equation 3) allows for the mass to be redistributed evenly across the system:

m^{α}(A|x)=(1−α)·m(A) ∀A⊂Ω,A≠Ø

m^{α}(A|x)=[(1−α)·m(A)]α A=Ø Equation 6

The degree that one chooses to discount by is of course related to the degree of precision in the powerset Θ, and shows how much existing hypotheses can be influenced by incoming data.

One can measure the precision, p, using Equation 7:

$$p ( m ) = Σ \frac{\vert Ω \vert - \vert A \vert}{\vert Ω \vert - 1} \times m ( A ) ∀ A \neq φ , A ⊆ Θ \qquad Equation 7$$

Here the magnitude signs mean the number of elements in the set in question. Any value, or mass, added to the empty set is treated as adding to the vagueness. There is a point to be decided as to whether the empty set is making the system vaguer, or it is adding precision, or in fact it should be ignored. If the empty set is adding precision, then:

$$p ( m ) = ( Σ \frac{\vert Ω \vert - \vert A \vert}{\vert Ω \vert - 1} \times m ( A ) ) + m ( φ ) ∀ A \neq φ , A ⊆ Θ \qquad Equation 8$$

If any belief given to the empty set is to be ignored, then to normalise one can use Equation 9:

$$p ( m ) = Σ \frac{\vert Ω \vert - \vert A \vert}{\vert Ω \vert - 1} \times \frac{m ( A )}{( 1 - m ( φ ) )} ∀ A \neq φ , A ⊆ Θ \qquad Equation 9$$

These equations, in particular Equation 7, are similar to those described in Stephanou et al., “Measuring Consensus Effectiveness by a Generalized Entropy Criterion”, IEEE Transactions on Pattern Analysis and Machine Intelligence, Vol. 10, No. 4, July 1988, pp. 544-554 (See, Definition 4.4, page 546).

The method in its entirety, for a sensor-based application, thus proceeds as follows:

Steps:

1. Set up the fused state, m_{fused}, with any prior knowledge, or as ignorant if no prior knowledge exists;

2. Receive (new) measurement from sensor;

3. Put the measurement into the powerset mₘₑₐₛᵤᵣₑₘₑₙₜ;

4. Work out the precision associated with m_{fused} using an appropriate one of Equations 7-9;

5. Discount mₘₑₐₛᵤᵣₑₘₑₙₜ by an amount derived from the precision ascertained in Step 4, using Equation 6, to get m_{measurementd};

6. Discount mₘₑₐₛᵤᵣₑₘₑₙₜ similarly, using Equation 5, to get m_{measurementc};

7. Disjunctively combine m_{fused} with m_{measurementd} to get m_{fusedd} using Equation 3;

8. Conjunctively combine m_{fused} with m_{measurementc} to get m_{fusedc} using Equation 4;

9. Combine m_{fusedd} and m_{fusedc} with the arithmetic mean operator, or other suitable operator, from Equation 2 to get a new m_{fused};

10. Return to 2, if there are still data to be processed.

Steps 4-6 are a significant part of the method and can be known as Dynamic Discounting.

FIG. 2 shows an application of the method to the identification of a vehicle moving along a path V. Sensors S1, S2 . . . are scattered over a terrain through which vehicles and personnel are expected to pass. The sensors can simply be proximity sensors, or they can give more sophisticated information about a passing vehicle. They pass their measurement data to a central control (which can itself be incorporated in one of the sensors) from which the speed and perhaps direction of travel of the vehicle can be estimated. Individual readings might be compatible with the vehicle being, say, a pedestrian, a bicycle or a car, but some will be much less probable. On the basis of many readings a best measurement can be obtained. If the system has a reasonably certain identification, a new measurement that is inconsistent with this conclusion does not disturb the consensus greatly, and it can be concluded (for instance) that a different vehicle has been detected from the one previously measured, or that the sensor has malfunctioned.

In summary, GRP1 is a general-purpose method for fusing independent measurements. It is intended for use in iterative situations where information relating to a target or object of measurement or event is received over time, e.g. from distributed sensors, and a belief about what it really is continually updated. It is also well suited to situations where the powerset being sensed is not fully understood. Example applications can be:

Target Classification—taking information from radar (etc.) sensors;

Behaviour Classification—taking information from accelerometers on a human;

Stress analysis—taking the readings from biomedical sensors on a human;

Systems welfare—receiving information on the status of a system;

Medical Diagnostics—for instance, if a patient has symptoms a, b, and c, what is the diagnosis; or if an MRI scan suggests condition a and an X-ray scan suggests condition a or b, what is the diagnosis?

Sensor Reliability Assessment;

Diagnostics within machinery, such as cars, factories etc.;

Combining weather measurements and predictions;

Combining the evidence from a number of sensors, e.g. for controlling a machine.

As can be seen, GRP1 is only limited by the types of information that can be sensed or collected and presented to it. Other combination operators are aimed at combining more than one source of information in a collective manner. The method is aimed at recursive and iterative use where information is received over time.

Methods of the invention thus:

1. Allow for iterative and recursive fusion of information;

2. Do not remove the empty set, which is an important measure (this allows open-world operation);

3. Dynamically adjust their own fusion parameters depending on the confidence of the system. This can create memory in the system.

1-13. (canceled)

14. A method for making a measurement of an object, comprising:
determining an initial state;
receiving new data;
adding the new data to a powerset;
combining disjunctively the new data with the initial state to determine a disjunctive data set;
combining conjunctively the new data with the initial state to determine a conjunctive data set; and
combining the disjunctive data set and the conjunctive data set using an average operator to determine a new average state.

15. The method of claim 14, further comprising assigning the new average state to the initial state for a subsequent iteration of the method.

16. The method of claim 14, further comprising reading an existing assessment before receiving the new data, wherein the existing assessment is the initial state.

17. The method of claim 14, further comprising:
evaluating a distribution across the initial state to determine a precision; and
discounting dynamically the powerset including the new data.

18. The method of claim 17, wherein the precision is determined based at least in part on equations 7, 8, and 9:
$$\begin{matrix}p ( m ) = Σ \frac{\vert Ω \vert - \vert A \vert}{\vert Ω \vert - 1} \times m ( A ) ∀ A \neq φ , A ⊆ Θ & Equation 7 \\ p ( m ) = ( Σ \frac{\vert Ω \vert - \vert A \vert}{\vert Ω \vert - 1} \times m ( A ) ) + m ( φ ) ∀ A \neq φ , A ⊆ Θ & Equation 8 \\ p ( m ) = Σ \frac{\vert Ω \vert - \vert A \vert}{\vert Ω \vert - 1} \times \frac{m ( A )}{( 1 - m ( φ ) )} ∀ A \neq φ , A ⊆ Θ & Equation 9\end{matrix}$$
where Ω is the union of all elements of the powerset and Ø is the empty set.

19. The method of claim 17, wherein the discount including the empty set is determined based at least in part on equation 6:
m^{α}(A|x)=(1−α)·m(A) ∀A⊂Ω,A≠Ø
m^{α}(A|x)=[(1−α)·m(A)]α A=Ø Equation 6

20. The method of claim 17, the step of discounting dynamically the powerset further comprising:
discounting disjunctively the powerset based on the precision; and
discounting conjunctively the powerset based on the precision.

21. The method of claim 20, wherein the discount ignoring the empty set is determined based at least in part on equation 5:
m^{α}(A|x)=(1−α)·m(A) ∀A⊂Ω,A≠Ω
m^{α}(A|x)=[(1−α)·m(A)]α A=Ω Equation 5

22. The method of claim 14, wherein combining disjunctively is based at least in part on Equation 3:
m_{1⊕2}(A)=Σ_{A=B∪C}m₁(B)m₂(C) Equation 3
and wherein m₁ and m₂ are two sets of information to be fused and B and C are alternative hypotheses within these powersets.

23. The method of claim 14, wherein combining conjunctively is based at least in part on Equation 4:
m₁ [symbol] ₂(A)=Σ_{A=B∩C}m₁(B)m₂(C) Equation 4

24. The method of claim 14, wherein at least the new data are measurements from one or more sensors.

25. The method of claim 24, wherein the one or more sensors are at least one of a position sensor, a speed sensor, a light sensor, an acoustic sensor, a lidar sensor, a radar sensor, and a camera-based sensor.

26. The method of claim 14, wherein the powerset is a description of a target.

27. The method of claim 14, wherein the powerset is a collection of data about at least one weather condition.

28. A system for making measurements of an object based on uncertain or incomplete data, comprising:
an input component configured to gather data about the object;
a fusion component configured to fuse the data with an initial state, wherein the fusion of the data with the initial state includes at least a disjunctive combination of the new data with the initial state and a conjunctive combination of the data with the initial state; and
a controller component including at least non-volatile computer readable media configured to receive the data.

29. The system of claim 28, further comprising one or more sensors.

30. The system of claim 29, wherein the one or more sensors are adapted for medical diagnosis.

31. The system of claim 28, further comprising a discounting component configured to dynamically discount the data.

32. The system of claim 31, wherein the discount is based at least in part on a precision.

33. The system of claim 32, wherein the precision is based at least in part on a distribution across the initial state.
